(19) United States
(12) Patent Application Publication
(10) Pub. No.: US 2012/0291336 A1
(43) Pub. Date: Nov. 22, 2012

(54) Systems, Devices, and Methods for Protection From Bedbugs

(76) Inventor: Herman L. Friend, Rockville Center, NY (US)

(21) Appl. No.: 13/108,403

(22) Filed: May 16, 2011

(51) Int. Cl. A01M 1/10; A01M 1/20; A01M 1/14

(52) U.S. Cl. 43/114; 43/131; 43/123

(57) ABSTRACT

A bedbug protective device has a carrier material, an attachment element coupled to the carrier material, and a sticky trap element coupled to the carrier material. The carrier material is impregnated with a bedbug repellent or insecticide. The carrier may be formed, for example, with its cross-section in a generally “C” shape with a back portion and first and second lip portions defining a channel, and with the first and second lip portions defining a longitudinal opening to the channel which is sized to permit bedbugs to enter the opening. The protective device first acts in a deterrent capacity, and secondly acts in a trapping capacity with respect to bedbugs.

### BACKGROUND OF THE INVENTION

1. Field of the Invention

The present invention relates broadly to devices and systems that repel and/or kill insects. More particularly, this invention relates to devices, systems, and methods for repelling and/or killing bedbugs.

2. State of the Art

The pest control industry is a large one which employs thousands of workers and nets billion of dollars in services annually. Over the last few years, one pest for which the industry's services are increasingly sought is the bedbug, Cimex lectularius which is a parasitic insect of the family Cimicidae. The nickname “bedbug” comes from the preferred habitats of the insect, which include houses, beds or other common areas where people sleep and dwell. While once controlled by chemicals such as DDT, with the banning of such chemicals, bedbugs have grown in number over the past decade to near epidemic proportions.

Bedbugs live by feeding on the blood of warm-blooded animals, such as humans. They are active at night, and after feeding return to their typically dark hiding places. Detection of bedbugs is difficult due to their small size, propensity for nocturnal activity, and choice of inconspicuous dwellings during the day. Thus, it is not uncommon for infestations to occur, especially in hotels.

Bedbug traps are known in the art. Generally, these traps include an attractant such as dry ice (as bedbugs are attracted to carbon dioxide), or a device such as a cup that is layered with talc which inhibits the crawling of the bedbug and which is intended to inhibit the bedbug from reaching its target. The traps on the market are generally relatively ineffective and/or unsightly.

### SUMMARY OF THE INVENTION

A bedbug protective device is provided that combines a bedbug repellent with a mechanism for trapping/killing bedbugs, and the protective device is readily attached to bed frames, beds, furniture, floors, etc., and is not unsightly.

According to one embodiment, the bedbug protective device is a flexible carrier strip of material which is impregnated with a bedbug repellent. The backside of the carrier is flat and provided with an adhesive strip. At least a portion of the front side of the carrier is coated along its length with a sticky glue. If desired, the carrier may define a channel with the front side of the carrier presenting one or more lips which define an opening to the inside of the carrier. In one embodiment, where a single lip is provided, the carrier is effectively “V”-shaped. In another embodiment, where two lips are provided, the carrier is effectively “C”-shaped. Where the carrier is C-shaped, the opening defined between the lips of the carrier is large enough for bedbugs to enter, but preferably sized so that it is not easy for a person to see inside.

The carrier is preferably formed of an extruded or molded rubber or polymer. The bedbug repellent is preferably geraniol, although DEET (N,N-Diethyl-meta-toluamide), pyrethroid, or other repellent and/or insecticidal additives may be utilized, preferably selected from the EPA 25b and 4A inert lists.

The carrier may be attached to bed frames, bed posts, head boards, mattresses, furniture, baseboards, floors, etc. The carrier may be provided in strips of a particular length (e.g., six feet or two meters long), or rolled into a flat roll which may be unrolled. In either case, the carrier is easily cut to size. In addition, or alternatively, carrier connecting elements such as curves or corner pieces may be formed (typically through molding).

### BRIEF DESCRIPTION OF THE DRAWINGS

FIG. 1A is a front perspective view of a first embodiment of carrier.

FIG. 1B is a back perspective view of the carrier of FIG. 1A.

FIG. 2A is a front perspective view of a second embodiment of a carrier.

FIG. 2B is a back perspective view of the carrier of FIG. 2A.

FIG. 3A is a front perspective view of a third embodiment of a carrier.

FIG. 3B is a back perspective view of the carrier of FIG. 3A.

FIG. 4 is a front perspective cut-away view of a fourth embodiment of a carrier.

FIG. 5 is a front perspective view of a fifth embodiment of a carrier.

FIG. 6 is a front perspective view of a sixth embodiment of a carrier.

FIG. 7 is a front perspective view of a corner piece which particularly matches the third embodiment of the carrier.

### DETAILED DESCRIPTION OF THE PREFERRED EMBODIMENTS

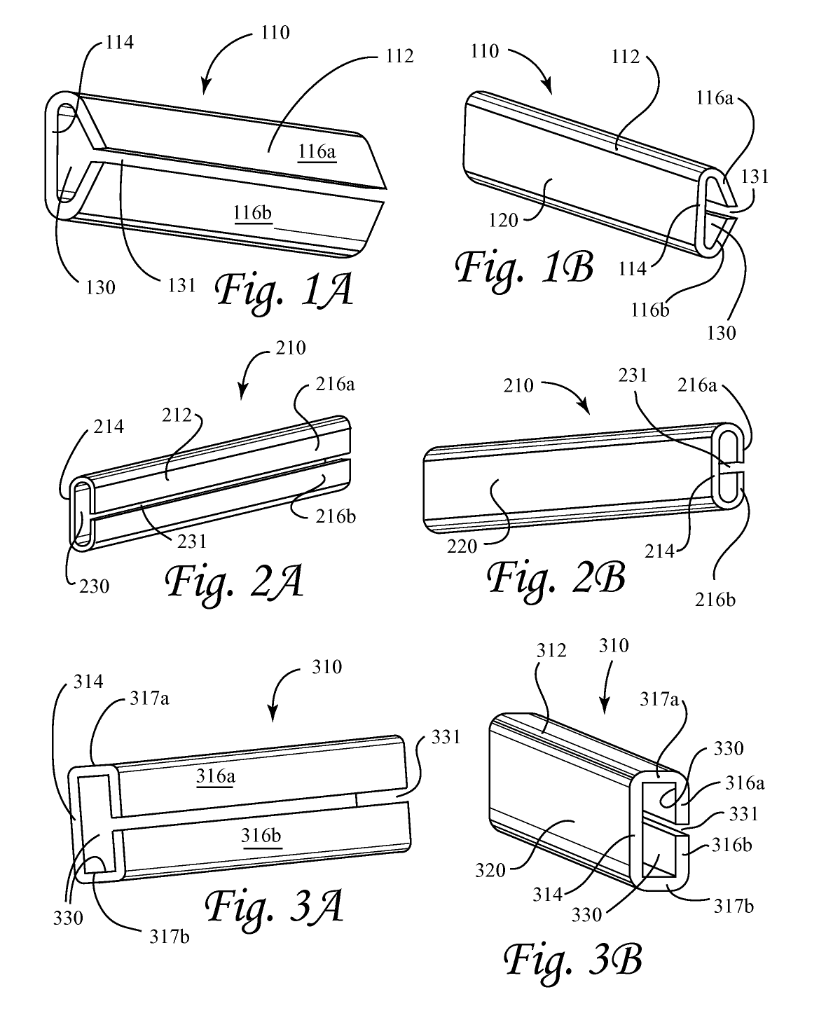

A first embodiment of a bedbug protective device 110 is seen in FIGS. 1A and 1B. Device 110 includes a carrier material 112 preferably formed of rubber or polymer which is formed with a cross-section in the general shape of a triangular “C” with a back 114 and front lips 116a, 116b defining a channel. At least a portion of the carrier material 112 along its entire length, and preferably, the entire carrier material 112 is impregnated with a bedbug repellent or insecticide adapted to repel bedbugs such as geraniol (and particularly the geraniol, geraniol precursor, or beta-geraniol glucocide substance described in the Background of U.S. Pat. No. 5,633,236 to Warren et al.), DEET, pyrethroid, or other repellent and/or insecticide selected from the EPA 25b and 4A inert lists, including but not limited to oils of citronella, peppermint, cedar, lemongrass, or soybean, or substances such as 1,8-cineol (1,3,3-trimethyl-2-oxabicyclo[2.2.2]octane, Para-menthane-3,8-diol (PMD), citronellol (3,7-dimethyl-oct-6-en-1-ol, citronellol acetate (acetic acid 3,7-dimethyl-oct-6-enyl ester); linalol (3,7dimethyl-octa- 1,6-dien-3-ol); [beta]-pinene(6,6-dimethyl-2-methylene-bicyclo[3.1.1]heptane); [alpha]-terpinol(2-(4-methyl-cyclohex-3-enyl)-propan-2-ol); d-limonene(4-isopropenyl-1-methyl- yclohexene); citronellal(3,7-dimethyloct-6-en-1-al); geranial(3,7-dimethyl-2,6-octadienal) or geraniol(3,7-dimethyl-2,6-octadien-1-ol). The insect repelling agents and/or carrier material is adapted such that the insect repellent agents are time released from the carrier over an extended period of time. More particularly, the rubber or polymer is preferably molded or extruded and is chosen from materials which permit slow release of the repellent or insecticide. Preferred materials for the carrier 112 include low and high density polyethylene, polyvinylchloride, and rubber, although other materials can be used, including but not limited to Polyacrylonitrile (PAN), Polyacrylates (PC), Polyesters (PES), polyethylene terephthalate (PET), polypropylene (PP), Nylon/Polyamide (PA), Ethylene-vinyl acetate copolymers (EVA), Polyvinyl pyrrolidone (PVP), Polyvinyl alcohol (PVA), and blends of any of the above. Optionally, by adding specialty additives to the polymers known to those skilled in the art of polymer chemistry, the carrier material is rendered substantially biodegradable, bio-erodable or compostable. However, as long as the film is water resistant it can also be of waxed or siliconised paper or any other water resistant thin material. Optionally, the carrier material 112 may also be impregnated with a fragrance that can mask (to humans) the scent of the repellent.

The back 114 of the carrier 112 is preferably flat and is provided with an adhesive strip 120 (i.e., attachment means). The attachment means may be a peel-off tape (i.e., tape with removable paper backing), Velcro, or other device which will permit the device 110 to be readily attached to bed frames, bed posts, head boards, mattresses, furniture, baseboards, floors and walls. The inside of carrier 112 provides a channel, at least part of whose surface along its entire length is coated with a natural or synthetic glue 130 which remains sticky or tacky such as are used on glue boards known in the art. Thus, a portion or the entirety of the front face of the back 114, and/or portions of or the entireties of the inside faces of the lips 116a, 116b can be provided with the glue.

The lips 116a, 116b of the carrier angle away from the back 114 and toward each other and define a longitudinal opening 131 which is parallel to the back wall 114. The opening is preferably between about 0.125 inches (about 3 mm) and 1.0 inches (about 25 mm), thereby being large enough for bedbugs to enter, but small enough so that it is not easy for a person to see inside the channel. The carrier 112 may be provided (as a kit) in multiple strips of one or more particular lengths (e.g., six feet or two meters long), or may be a single long strip (e.g., 25 or 50 feet long) rolled into a flat roll (similar to a rolled hose) which may be unrolled and cut to size. In one embodiment, the carrier 112 is relatively flexible so that it can be readily bent around a curved surface and may be rolled into a flat roll. In another embodiment, the carrier 112 may be relatively inflexible. In either case, as described hereinafter with reference to FIG. 7, corner pieces may be utilized to connect strips.

The bedbug protective device 110 is preferably utilized by taking a strip or roll of the device, cutting it to size if required, peeling off the paper backing (if provided) on the adhesive strip, and attaching the adhesive strip to an object (e.g., a bed frame) or surface (e.g., a floor) so that the protective device 110 forms a part of or an entire periphery about the area to be protected. If the protective device forms only part of the periphery, the process is repeated with one or more additional strips of protective device which is/are laid adjacent the first strip and/or each other and/or adjacent one or more corner pieces until a substantially continuous periphery (i.e., with no cracks large enough through which a bedbug could crawl) around the area to be protected is established.

A second embodiment of a bedbug protective device 210 is seen in FIGS. 2A and 2B. Other than its shape, device 210 is substantially the same as device 110, and like parts of device 210 are denoted with like numerals except “100” larger. Thus, device 210 includes a carrier material 212 preferably formed of a molded or extruded relatively flexible rubber or polymer which is formed with a cross-section generally in the shape of an oblong “C” with a back 214, and with front lips 216a, 216b connected to back 214 by rounded top and bottom portions 217a, 217b. The carrier material 212 is impregnated with a bedbug repellent or insecticide as previously described. The back 214 of the carrier 212 is preferably flat and is provided with an adhesive strip 220 which will permit the device 210 to be readily attached to bed frames, bed posts, head boards, mattresses, furniture, baseboards, floors and walls. The inside of carrier 212 provides a channel at least a portion of whose surface is preferably coated with a glue 230 as previously described. The lips 216a, 216b of the carrier are generally parallel the back 214 and define a longitudinal opening 231 which is preferably between about 0.125 inches (about 3 mm) and 1 inch (25 mm) wide, thereby being large enough for bedbugs to enter, but small enough so that it is not easy for a person to see inside the channel. The carrier 212 may be provided in kit form as one or more strips of one or more particular lengths, or as a single long strip (e.g., 25 or 50 feet long) rolled into a flat roll (similar to a rolled hose) which may be unrolled and cut to size.

Bedbug protective device 210 is preferably utilized in the same manner described above with reference to bedbug protective device 110.

A third embodiment of a bedbug protective device 310 is seen in FIGS. 3A and 3B. Other than its shape, device 310 is substantially the same as device 110, and like parts of device 310 are denoted with like numerals except “200” larger. Thus, device 310 includes a carrier material 312 preferably formed of a molded or extruded relatively flexible rubber or polymer which is formed with a cross-section generally in the shape of a rectangular “C” with a back 314, and with front lips 316a, 316b that are connected to the back 314 by generally flat top and bottom portions 317a, 317b. The carrier material 312 is impregnated with a bedbug repellent or insecticide as previously described. The back 314 of the carrier 312 is preferably flat and is provided with an adhesive strip 320 which will permit the device 310 to be readily attached to bed frames, bed posts, head boards, mattresses, furniture, baseboards, floors and walls. If desired, in addition to or instead of adhesive strip 320, an adhesive strip (not shown) may be provided on the bottom and/or top portions 317a, 317b of the carrier 312. The inside of carrier 312 provides a channel at least a portion of whose surface is preferably coated with a glue 330 as previously described. The lips 316a, 316b of the carrier are generally parallel the back 314 and define a longitudinal opening 331 which is preferably between about 0.125 inches (about 3 mm) and 1 inch (about 25 mm) thereby being large enough for bedbugs to enter, but small enough so that it is not easy for a person to see inside the channel. The carrier 312 may be provided in kit form as one or more strips of one or more particular lengths, or as a single long strip (e.g., 25 or 50 feet long) rolled into a flat roll (similar to a rolled hose) which may be unrolled and cut to size.

Bedbug protective device 310 is preferably utilized in the same manner described above with reference to bedbug protective device 310, except that where the top and/or bottom portions 317a, 317b of device 310 is provided with an adhesive strip, either the top or bottom portion may be attached to an object or surface via its adhesive strip rather than via an adhesive strip attached to the back 314 of the carrier material 312.

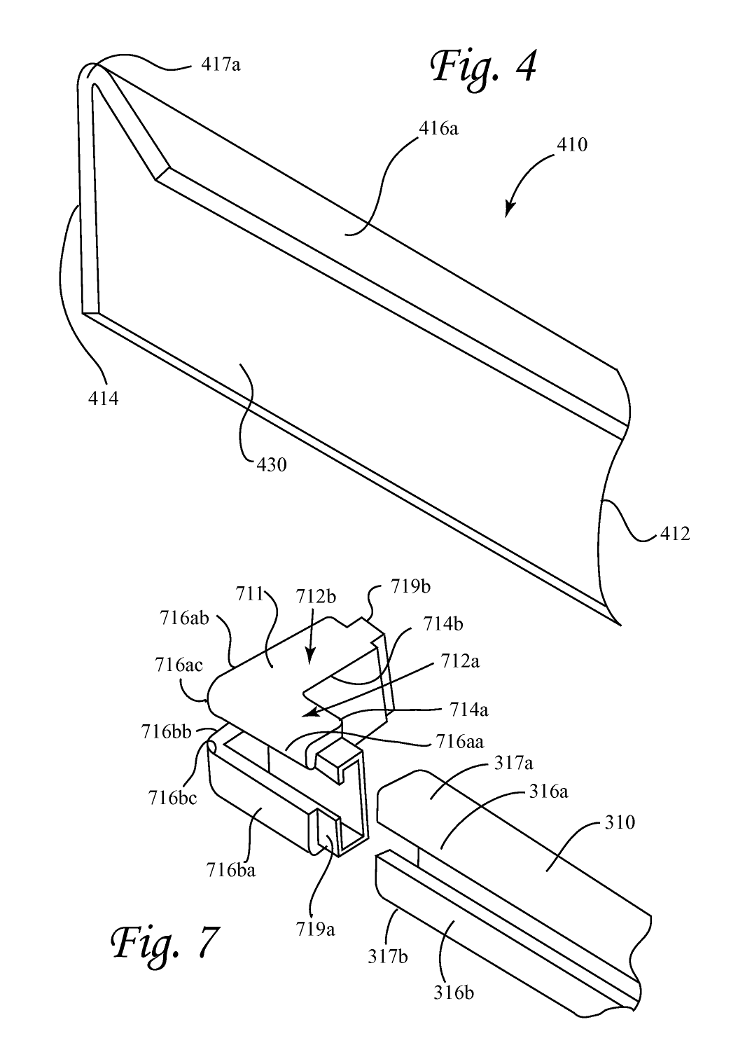

Turning to FIG. 4, a fourth embodiment of a bedbug protective device 410 is seen. Device 410 is similar to device 110, and like parts of device 410 are denoted with like numerals except “300” larger. Thus, device 410 includes a carrier material 412 preferably formed of a molded or extruded relatively flexible rubber or polymer which is formed with a back 414, and a single front lip 416a connected to back 414 by rounded top portions 417a. The carrier material 412 is impregnated with a bedbug repellent or insecticide as previously described. The back 414 of the carrier 412 is preferably flat and is provided with an adhesive strip (not shown) which will permit the device 410 to be readily attached to bed frames, bed posts, head boards, mattresses, furniture, baseboards, floors and walls. The front (inside) of carrier 412 provides a channel at least a portion of whose surface is preferably coated with a glue 430 as previously described. The lip 416a is shown angled relative to the back 414, but may be parallel if desired. The carrier 412 may be provided in kit form as one or more strips of one or more particular lengths, or as a single long strip (e.g., 25 or 50 feet long) rolled into a flat roll (similar to a rolled hose) which may be unrolled and cut to size.

Bedbug protective device 410 is preferably utilized in the same manner described above with reference to bedbug protective device 110.

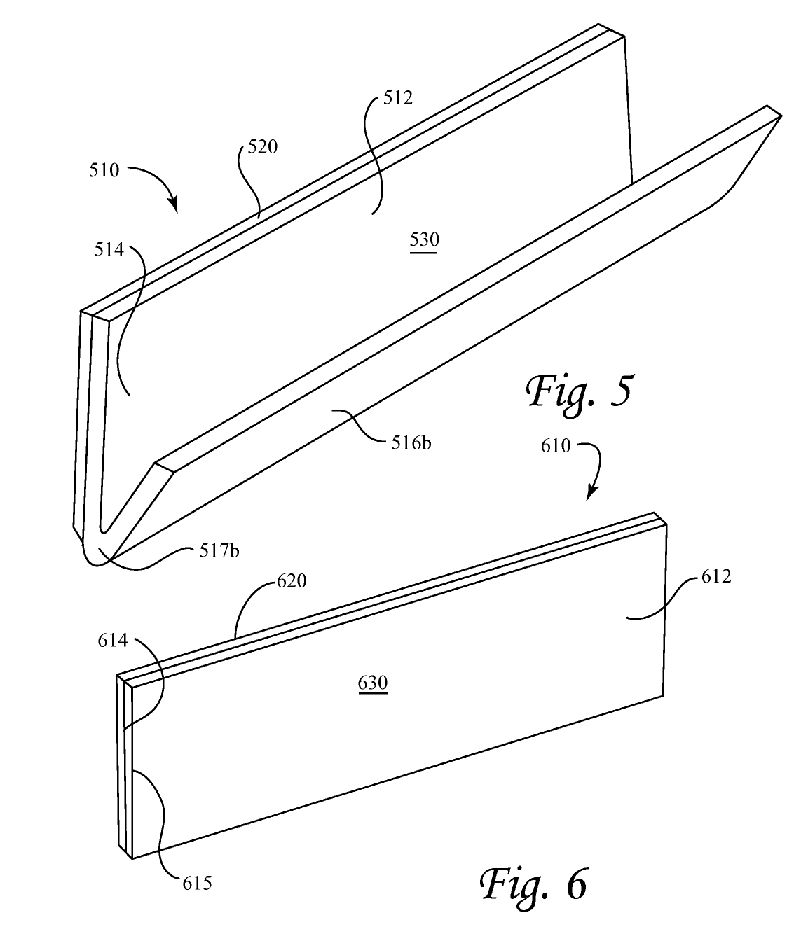

Turning to FIG. 5, a fifth embodiment of a bedbug protective device 510 is seen. Device 510 is similar to device 410, and like parts of device 510 are denoted with like numerals except “100” larger. Thus, device 510 includes a carrier material 512 preferably formed of a molded or extruded relatively flexible rubber or polymer which is formed with a back 514, and a single front lip 516b connected to back 514 by rounded bottom portion 517b. The carrier material 512 is impregnated with a bedbug repellent or insecticide as previously described. The back 514 of the carrier 512 is preferably flat and is provided with an adhesive strip 520 which will permit the device 510 to be readily attached to bed frames, bed posts, head boards, mattresses, furniture, baseboards, floors and walls. The front (inside) of carrier 512 provides a channel at least a portion of whose surface is preferably coated with a glue 530 as previously described. The lip 516b is shown angled relative to the back 514, but may be parallel if desired. The carrier 512 may be provided in kit form as one or more strips of one or more particular lengths, or as a single long strip (e.g., 25 or 50 feet long) rolled into a flat roll (similar to a rolled hose) which may be unrolled and cut to size.

Bedbug protective device 510 is preferably utilized in the same manner described above with reference to bedbug protective device 110.

A sixth embodiment of a bedbug protective device 610 is seen in FIG. 6. Device 610 has similarities to device 110, and like parts of device 610 are denoted with like numerals except “500” larger. Thus, device 610 includes a carrier material 612 preferably formed of a molded or extruded relatively flexible rubber or polymer which is formed as a strip with a back 614 and front 615. The back 614 of carrier material 612 is impregnated with a bedbug repellent or insecticide as previously described. The carrier 612 is preferably flat and is provided with an adhesive strip 620 which will permit the device 610 to be readily attached to bed frames, bed posts, head boards, mattresses, furniture, baseboards, floors and walls. The front 615 of carrier 612 provides a surface at least a portion of which along its length is preferably coated with a glue 630 as previously described. The carrier 612 may be provided in kit form as one or more strips of one or more particular lengths, or as a single long strip (e.g., 25 or 50 feet long) rolled into a flat roll (similar to a rolled hose) which may be unrolled and cut to size.

Bedbug protective device 610 is preferably utilized in the same manner described above with reference to bedbug protective device 110.

It should be appreciated that while the bedbug protective devices described are preferably formed as strips made from a relatively flexible rubber or polymer that can be laid into a continuous periphery, either by curving the strips, or by laying a plurality of strips adjacent each other, if desired, connecting or corner pieces may also be utilized. Thus, as seen in FIG. 7, a corner piece 711 is provided which closely matches the bedbug protective device 310 of FIGS. 3A and 3B. It will be appreciated that other corner pieces which match the protective devices 110, 210, 410, 510, 610 may similarly be provided. Corner piece 711 is shown as an outside corner piece, and includes a carrier material 712 with two perpendicular sections 712a, 712b preferably unitarily molded from relatively flexible rubber or polymer. Each section is formed with a cross-section generally in the shape of a rectangular “C” with a back 714a, 714b, and with front lips 716aa, 716ab, 716ba, 716bb. Because of the two-hundred seventy degree bend in the corner piece 711, the front lips 716aa, 716ba and 716ab, 716bb are shown connected by corner arced sections 716ac, 716bc. It is noted that if the corner piece was an inside corner piece with a ninety-degree bend, the connections between the lips would be accommodated differently. Regardless, the carrier material 712 is impregnated with a bedbug repellent or insecticide as previously described. The back portions 714a, 714b of the carrier sections 712a, 712b are preferably flat and are provided with adhesive strips 720a, 720b which will permit the device 710 to be readily attached to a corner of an object, e.g., a bed frame, mattress, baseboard, etc. If desired, in addition to or instead of adhesive strips 720a, 720b, adhesive strips (not shown) may be provided on the bottom and/or top portions of the carrier sections 712a, 712b. The inside of carriers 712a, 712b provide a channel at least a portion of whose surface is preferably coated with a glue (not shown) as previously described.

The corner piece 711 is preferably utilized by peeling off the paper backing (if provided) on the adhesive strip(s), and attaching the adhesive strip(s) to the baseboard of an object (e.g., a bed frame) or surface (e.g., a floor) so that the protective device 711 forms a part of a periphery about the area to be protected. Prior to or after the attachment of the corner piece 711 to an object or surface, additional strips of protective device are laid such that the corner piece 711 in conjunction with the additional strips will form a substantially continuous periphery (i.e., with no cracks large enough through which a bedbug could crawl) around the area to be protected. Alternatively, and as shown in FIG. 7, the corner piece 711 may be provided with one or more flanges 719a, 719b which are adapted to mate with straight pieces such as device 310 shown in FIG. 7. Thus, flanges 719a, 719b may be arranged such that they slide completely inside the channel of the adjacent device. Alternatively, the adjacent device may have a back wall portion partially cut away (as seen in FIG. 7), so that the flange provides the back wall, and so that top and bottom walls 317a, 317b (and optionally the lips 316a, 316b) slide over and mate with various parts of the flange (e.g., thinner top and bottom walls and thinner top and bottom lips).

A novel aspect of all of the embodiments of the protective devices 110, 210, 310, 410, 510, 610, 711 is that bedbugs are repelled rather than attracted to the protective devices due to the repellent or insecticide impregnated in the carrier of the device. However, should a bedbug's desire to feed overcome its instinct to stay away from the repellent or insecticide of the carrier, the bedbug will necessarily crawl on the protective device where it will get trapped on the sticky glue and die. Thus, the protective device first acts in a deterrent capacity, and secondly acts in a trapping capacity.

There have been described and illustrated herein several embodiments of a bedbug protective device and a method of its use. While particular embodiments of the invention have been described, it is not intended that the invention be limited thereto, as it is intended that the invention be as broad in scope as the art will allow and that the specification be read likewise. Thus, while particular carrier materials have been disclosed, it will be appreciated that other materials could be used as well. In addition, while particular types of repellents and insecticides have been disclosed, it will be understood that others can be used. Also while particular attachment means have been described, it will be understood that other attachment means can be similarly used. Further, while particular shapes for the carrier material have been described, it will be appreciated that other shapes could be utilized. In fact, the carrier material can be formed as strips with connecting elements which link to each other and/or to corner elements. It will therefore be appreciated by those skilled in the art that yet other modifications could be made to the provided invention without deviating from its spirit and scope as claimed.

What is claimed is:

1. A bedbug protective device, comprising:
a strip of carrier material impregnated with a bedbug repellent or insecticide;
an attachment means attached to a first side of said carrier material and adapted to attach said bedbug protective device to an object or surface; and
sticky trap means located on said carrier material on other than said first side of said carrier material for trapping bedbugs which crawl onto said sticky trap means.

2. A bedbug protective device according to claim 1, wherein:
said strip of carrier material includes a back portion on which said attachment means is attached and at least one lip extending from said back portion.

3. A bedbug protective device according to claim 2, wherein:
said at least one lip comprises first and second lips, said first and second lips and said back portion together providing said strip of carrier material with a cross-section in a generally “C” shape, and said first and second lips defining a longitudinal opening to the channel sized to permit bedbugs to enter a longitudinal opening defined between said first and second lips.

4. A bedbug protective device according to claim 3, wherein:
said carrier material is a rubber or polymer material.

5. A bedbug protective device according to claim 4, wherein:
said carrier material is formed by molding or extrusion.

6. A bedbug protective device according to claim 1, wherein:
said bedbug repellent or insecticide comprises geraniol, a geraniol precursor, a beta-geraniol glucocide, DEET, or pyrethroid.

7. A bedbug protective device according to claim 6, wherein:
said carrier material is further impregnated with a fragrance which masks for humans said bedbug repellent or insecticide.

8. A bedbug protective device according to claim 1, wherein:
said attachment means comprises tape with removable paper backing

9. A bedbug protective device according to claim 1, wherein:
said sticky trap means comprises glue.

10. A bedbug protective device according to claim 3, wherein:
said generally “C” shape comprises a generally triangular “C” shape with said first and second lips angling away from said back portion and toward each other to define said longitudinal opening.

11. A bedbug protective device according to claim 3, wherein:
said generally “C” shape comprises a generally oblong “C” shape.

12. A bedbug protective device according to claim 3, wherein:
said generally “C” shape comprises a generally rectangular “C” shape.

13. A bedbug protective device according to claim 3, wherein:
said longitudinal opening between said first and second lips is between 3 mm and 25 mm wide.

14. A bedbug protective device according to claim 1, wherein:
said attachment means comprises tape with removable paper backing

15. A bedbug protective device according to claim 1, wherein:
said carrier material with said attachment means and said sticky trap means is arranged as a long strip rolled into a flat roll.

16. A kit comprising a plurality of bedbug protective devices according to claim 1 cut to predetermined sizes.

17. A kit comprising a bedbug protective device according to claim 1 and at least one unitary bedbug protective corner piece having perpendicular portions, a second attachment means attached to first sides of said perpendicular portions of said second carrier material and adapted to attach said corner piece to a corner of said object or surface, and second sticky trap means located on said second carrier material on other than said first sides of said perpendicular portions for trapping bedbugs which crawl onto said second sticky trap means.

18. A kit according to claim 17, wherein:
said second carrier material is made from the same material as said strip of carrier material,
said second attachment means is the same as said attachment means attached to said first side of said carrier material, and
said second sticky trap means is the same as said sticky trap means located on said carrier material.

19. A kit according to claim 17, wherein:
said at least one corner piece has a flange adapted to mate with said protective device.

20. A method of protecting an area from bedbugs, utilizing at least one bedbug protective device according to claim 1, comprising:
using said attachment means, attaching said at least one bedbug protective device to an object or surface so that said at least one bedbug protective device forms a substantially continuous periphery about said area.

21. A method of protecting an area from bedbugs, utilizing said kit according to claim 17, comprising:
using said second attachment means, attaching at least one said corner piece to at least one said corner of said object or surface, and
using said attachment means, attaching said bedbug protective device to said object or surface adjacent said at least one said corner piece to form a substantially continuous periphery about said area.

22. A method of protecting an area from bedbugs utilizing said kit according to claim 19, comprising:
mating said corner piece to said bedbug protective device,
using said second attachment means, attaching at least one said corner piece to at least one said corner of said object or surface, and
using said attachment means, attaching said bedbug protective device to said object or surface adjacent said at least one said corner piece to form a substantially continuous periphery about said area.
